(19) United States
(12) Patent Application Publication
(10) Pub. No.: US 2013/0032980 A1
(43) Pub. Date: Feb. 7, 2013

(54) INSTALLATION AND METHOD FOR CLEANING AND/OR DEBURRING WORKPIECES

(71) Applicant: Dürr Ecoclean GmbH, Filderstadt (DE)

(72) Inventors: Hermann-Josef David, Monschau (DE); Egon Käske, Aachen (DE)

(73) Assignee: Dürr Ecoclean GmbH, Filderstadt (DE)

(21) Appl. No.: 13/647,978

(22) Filed: Oct. 9, 2012

Related U.S. Application Data
(63) Continuation of application No. PCT/EP2011/056765, filed on Apr. 28, 2011.

(30) Foreign Application Priority Data
May 3, 2010 (DE) 10 2010 028 489.0

(51) Int. Cl. B23Q 3/00

(52) U.S. Cl. 269/14

(57) ABSTRACT

To provide an installation for cleaning and/or deburring workpieces, comprising a treatment region configured to enable a cleaning treatment and/or a deburring treatment to be performed on a workpiece therein, a loading device for transferring the workpiece from an outer area of the installation into the treatment region and an unloading device for transferring the workpiece from the treatment region into the outer area of the installation, with which installation there is achieved a high workpiece throughput with a favourable cleaning and/or deburring result, it is proposed that the loading device and/or the unloading device comprises at least one treatment device configured to enable the workpiece to be treated during the transfer between the outer area of the installation and the treatment region of the installation.

### RELATED APPLICATION

This application is a continuation application of PCT/EP2011/056765 filed on Apr. 28, 2011, the entire specification of which is incorporated herein by reference.

### FIELD OF DISCLOSURE

The present invention relates to an installation for cleaning and/or deburring workpieces, which comprises a treatment region configured to enable a cleaning treatment and/or a deburring treatment to be performed on a workpiece therein, a loading device for transferring the workpiece from an outer area of the installation into the treatment region and an unloading device for transferring the workpiece from the treatment region into the outer area of the installation.

### BACKGROUND

Known installations for cleaning workpieces are used in the mechanical machining of engine components, in particular cylinder heads, for example, to remove contaminants resulting from swarf and cooling lubricants from the workpieces, in particular from the cylinder heads, in an operationally reliable manner, so that the contaminants cannot interfere with subsequent assembly processes and subsequently lead to engine damage.

Cleaning installations that are used to remove such contaminants often comprise an integrated handling system, for example a robot. For loading and unloading the cleaning installation with workpieces it is known to use a robot, which reaches out beyond a large door opening and removes a workpiece from a workpiece transport belt or loads a workpiece onto a workpiece transport belt.

As an alternative hereto it is also known to use rotary tables, by means of which a workpiece is transported into the cleaning installation and out of the cleaning installation by means of a 180° rotational movement.

However, the cycle time in the aforementioned machine designs is often too long because too much time is required for loading and unloading the installation with workpieces.

### SUMMARY OF THE INVENTION

The object underlying the present invention is to provide an installation for cleaning and/or deburring workpieces of the aforementioned type, with which a high workpiece throughput is achieved with a favourable cleaning and/or deburring result.

This object is achieved according to the invention with an installation for cleaning and/or deburring workpieces with the features of the preamble of claim 1 in that the loading device and/or the unloading device comprises at least one treatment device configured to enable the workpiece to be treated during the transfer between the outer area of the installation and the treatment region of the installation.

Therefore, the concept underlying the present invention is to configure the loading device and/or the unloading device of the installation for cleaning and/or deburring workpieces such that in parallel to the treatment operations in the treatment region of the installation a pretreatment of a workpiece can take place in the loading device before the treatment of the workpiece in the treatment region, and/or an aftertreatment of a workpiece can take place in the unloading device after the treatment of the workpiece in the treatment region.

In comparison to an installation, in which a first workpiece is delivered to the pretreatment, the main treatment and the aftertreatment operations in succession before the next workpiece can be delivered to the pretreatment operation, in the installation according to the invention optimum use is made of the cycle time, since it is possible to conduct a pretreatment of another workpiece in the loading device and/or an aftertreatment of a further workpiece in the unloading device simultaneously with the main treatment of a workpiece in the treatment region of the installation.

By means of a pretreatment in the loading device the workpiece can already be precleaned in particular, as a result of which the feed of contaminants into a cleaning bath of the installation can be reduced and the cleaning result can thus be improved.

Moreover, the service life of a bath in the treatment region of the installation can be extended.

In principle, the loading device of the installation according to the invention can comprise one or more treatment devices of any desired type.

It is preferably provided that the loading device comprises as treatment device a spray cleaning device, a dry cleaning device and/or a deburring device, in particular a brush deburring device.

In principle, the unloading device can also comprise one or more treatment devices of any desired type.

It is preferably provided that the unloading device comprises as treatment device a flushing device, a drying device and/or a cleanness checking device.

The cleaning result is improved by an aftertreatment of a workpiece in the unloading device in the form of a flushing operation.

Alternatively or additionally hereto, a drying operation can be conducted in the unloading device, in which before a vacuum drying operation, for example, the workpiece is pre-dried by the application of blown air, as a result of which the drying result is improved.

Alternatively or additionally to a cleaning or drying treatment, the cleanness value of the workpiece obtained can also be checked during the aftertreatment in the unloading device.

For this, it can be provided that at least one sensor that measures the cleanness of the workpiece is installed in the unloading device.

Alternatively or additionally hereto, it can be provided that the unloading device comprises a rinsing device for rinsing off the workpiece with a flushing liquid and that the installation comprises an analysing device for analysing the degree of contamination of the flushing liquid after rinsing off the workpiece. The achieved cleanness of the workpiece can be deduced from the degree of contamination of the flushing liquid after the workpiece has been rinsed off therewith.

In a preferred configuration of the installation according to the invention it is provided that the installation comprises an internal transport device configured to enable the workpiece to be taken up by the loading device and delivered to the treatment operation in the treatment region and/or delivered to the unloading device after treatment in the treatment region.

Such an internal transport device can comprise in particular a handling device, for example a robot.

The internal transport device preferably has at least three, particularly preferred at least four, in particular at least five, for example at least six, degrees of freedom.

Moreover, in a preferred configuration of the invention it is provided that the installation comprises an external transport device configured to enable the workpiece to be delivered to the loading device and/or to be taken up by the unloading device.

Such an external transport device can comprise in particular a handling device, for example a robot, a gantry crane and/or a roller conveyor.

The external transport device also preferably has at least three, particularly preferred at least four, in particular at least five, for example at least six, degrees of freedom.

At least one treatment device of the loading device and/or at least one treatment device of the unloading device can be static.

In this case, the workpiece is preferably moved past the respective treatment device of the loading device or the unloading device by means of a workpiece movement device during the pretreatment or during the aftertreatment.

Alternatively or additionally hereto, it can also be provided that at least one treatment device of the loading device and/or at least one treatment device of the unloading device is movable with the workpiece during the pretreatment or during the aftertreatment.

In order to prevent contaminants and/or cleaning medium from passing out of the loading device and/or out of the unloading device into the outer area of the installation or out of the outer area of the installation into the loading device and/or into the unloading device, it is advantageous if an outer workpiece passage between the outer area of the installation and the loading device and/or an outer workpiece passage between the outer area of the installation and the unloading device is closable by means of a door, in particular by means of a bulkhead door.

In order to prevent contaminants and/or cleaning medium from passing out of the loading device and/or out of the unloading device into the treatment region of the installation or out of the treatment region of the installation into the loading device and/or into the unloading device, it is additionally favourable if an inner workpiece passage between the treatment region of the installation and the loading device and/or an inner workpiece passage between the treatment region of the installation and the unloading device is closable by means of a door, in particular by means of a bulkhead door.

To be able to move the workpiece through the loading device to the treatment region and/or from the treatment region through the unloading device, it can be provided that the loading device and/or the unloading device comprises a linear workpiece movement arrangement.

Such a linear workpiece movement arrangement can comprise, for example, a linearly movable workpiece carriage, a roller conveyor, a conveyor belt and/or a walking beam conveyor.

Alternatively or additionally hereto, it can also be provided that the loading device and/or the unloading device comprises a rotation device for moving the workpiece.

In a particular configuration of the invention it is provided that the loading device and the unloading device have an associated common rotation device for moving the workpiece from the outer area of the installation into the treatment region and from the treatment region into the outer area of the installation.

By means of such a common rotation device the transport of the workpiece from the outer area into the treatment region of the installation and from the treatment region of the installation into the outer area thereof can be achieved in a particularly simple manner and with particularly low equipment expenditure.

In this case it is preferably provided that the rotation device has at least four working positions for the workpiece, into which the workpiece is movable in consecutive cycles.

In this case, in particular a first working position can be provided for loading the rotation device with the workpiece and for removing the workpiece from the rotation device, a second working position can be provided for conducting the pretreatment on the workpiece, a third working position can be provided for removing the workpiece into the treatment region, conducting the main treatment in the treatment region and returning the treated workpiece to the rotation device and a fourth working position can be provided for conducting the aftertreatment of the workpiece.

It is additionally favourable if the rotation device has at least four workpiece seatings, which can be loaded with workpieces independently of one another.

It is particularly favourable if the four workpiece seatings are separated from one another by partition walls, so that a treatment conducted on one of the workpieces held on the rotation device does not have an effect on the other workpieces held on the rotation device at the same time.

The present invention additionally relates to a method for cleaning and/or deburring workpieces, which comprises the following method steps:
transferring a workpiece from an outer area of the installation into a treatment region of the installation;
conducting a cleaning treatment and/or a deburring treatment on the workpiece in the treatment region;
transferring the workpiece from the treatment region of the installation into the outer area of the installation.

A further object underlying the present invention is to provide such a method for cleaning and/or deburring workpieces, by means of which a high workpiece throughput is achievable with a favourable cleaning and/or deburring result.

This object is achieved according to the invention with a method with the features of the preamble of claim 15 in that the workpiece is pretreated during the transfer from the outer area of the installation into the treatment region of the installation and/or is aftertreated during the transfer from the treatment region of the installation into the outer area of the installation. In this case, the concept of aftertreatment of the workpiece includes a detection of the treatment success of a preceding treatment.

The method according to the invention can be conducted in particular by means of the installation for cleaning and/or deburring workpieces according to the invention.

The installation for cleaning and/or deburring workpieces according to the invention can preferably be used to conduct the method according to the invention.

Further features and advantages of the invention are the subject of the following description and the graphical representation of exemplary embodiments.

### BRIEF DESCRIPTION OF THE DRAWINGS

FIG. 1 is a schematic basic diagram of an installation for cleaning and/or deburring workpieces with a treatment region, a loading device for transferring workpieces from an outer area of the installation into the treatment region and an unloading device for transferring workpieces from the treatment region into the outer area of the installation, wherein the loading device and the unloading device respectively comprise a linear workpiece movement arrangement; and

FIG. 2 is a schematic basic diagram of a second embodiment of an installation for cleaning and/or deburring workpieces, in which the loading device and the unloading device have an associated common rotation device for moving workpieces from the outer area of the installation into the treatment region and from the treatment region into the outer area of the installation.

Identical or functionally equivalent elements are given the same reference numerals in all the figures.

### DETAILED DESCRIPTION OF THE INVENTION

A first embodiment of an installation for cleaning and/or deburring workpieces102, given the overall reference 100, comprises a treatment region 104, which is arranged in a treatment chamber 106 and which is configured to enable a cleaning treatment and/or a deburring treatment to be performed on the workpiece 102 therein by means of one or more treatment devices (not shown).

To transfer a respective workpiece 102 from an outer area 108 of the installation 100 into the treatment region 104, the installation 100 comprises a loading device 110 with a loading chamber 112, which has an outer workpiece passage 114, through which a workpiece 102 is transferable from the outer area 108 into the interior 122 of the loading chamber 112, and an inner workpiece passage 116, through which a workpiece 102 is transferable from the interior 122 of the loading chamber 112 into the treatment region 104.

The outer workpiece passage 114 is closable by means of an outer door 118 and the inner workpiece passage 116 is closable by means of an inner door 120.

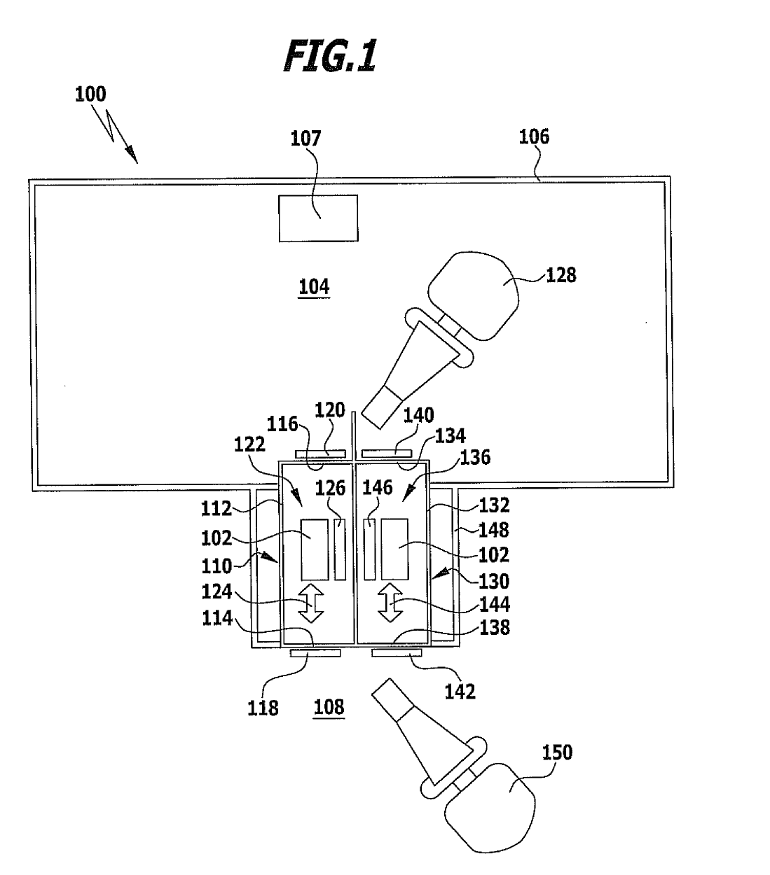

A linear workpiece movement arrangement, by means of which a workpiece 102 is movable through the interior 122 of the loading chamber 112 from the outer workpiece passage 114 to the inner workpiece passage 116, is arranged in the interior 122 of the loading chamber 112. This linear workpiece movement arrangement of the loading device 110 is symbolised by the arrow 124 in FIG. 1.

The loading device 110 additionally comprises one or more treatment devices 126 configured to enable a workpiece 102 to be pretreated during the transfer between the outer area 108 and the treatment region 104 in the interior 122 of the loading chamber 112 before the treatment in the treatment region 104.

Such a treatment device 126 of the loading device 110 can be configured, for example, as a spray cleaning device or as a dry cleaning device, so that a workpiece 102 can be subjected to a precleaning operation in the loading chamber 112 before the workpiece 102 is subjected to a main cleaning operation and/or a deburring operation in the treatment region 104.

Alternatively or additionally hereto, as treatment device 126 the loading device 110 can also comprise a deburring device, in particular a brush deburring device, so that a workpiece 102 can be subjected to a deburring operation, in particular a brush deburring operation, in the loading chamber 112.

An internal transport device 128, which is configured to enable a workpiece 102 to be taken up by the loading device 110 and delivered to the treatment device 107 in the treatment region 104, is arranged in the treatment region 104.

The internal transport device 128 can be configured in particular as a handling device, for example a robot.

The internal transport device 128 preferably has at least three, particularly preferred at least four, in particular at least five, for example at least six, degrees of freedom.

After the treatment in the treatment region 104 by means of the treatment device 107 the treated workpiece 102 is able to be delivered to an unloading device 130 of the installation 100 by means of the internal transport device 128.

The unloading device 130 comprises an unloading chamber 132 with an inner workpiece passage 134, through which a workpiece 102 is transferable from treatment region 104 into the interior 136 of the unloading chamber 132, and an outer workpiece passage 138, through which a workpiece 102 is transferable from the interior 136 of the unloading chamber 132 into the outer area 108 of the installation 100.

The inner workpiece passage 134 can be closable by means of an inner door 140 and the outer workpiece passage 138 can be closable by means of an inner door 142.

To move a workpiece 102 from the inner workpiece passage 134 to the outer workpiece passage 138, the unloading device 130 comprises a linear workpiece movement arrangement, which is symbolised by the arrow 144 in FIG. 1.

In addition there are arranged in the interior 136 of the unloading chamber 132 one or more treatment devices 146, which are configured to enable a workpiece 102 to be aftertreated in the interior 136 of the unloading chamber 132 after the treatment in the treatment region 104, during the transfer between the treatment region 104 and the outer area 108 of the installation 100.

The treatment device 146 of the unloading device 130 can be configured, for example, as a flushing device, as a dry cleaning device and/or as a cleanness checking device.

If the treatment device 146 is configured as a cleanness checking device, then it can be provided that this cleanness checking device comprises a rinsing device for rinsing off a workpiece 102 with a flushing liquid.

In addition, the installation 100 in this case preferably comprises an analysing device (not shown) for analysing the degree of contamination of the flushing liquid, with which the workpiece 102 has been rinsed off, to be able to deduce the residual contamination of the workpiece 102 from the degree of contamination of the flushing liquid after the treatment in the treatment region 104.

The treatment device 146 of the unloading device 130 can be substantially static in the interior 136 of the unloading chamber 132.

Alternatively hereto, it can be provided that the treatment device 146 is at least partially movable with the workpiece 102 during the aftertreatment in the unloading chamber 132.

The unloading device 130 and the loading device 110 of the installation 100 can be accommodated in a loading and unloading housing 148 of the installation 100.

The installation 100 additionally comprises an external transport device 150, which is arranged in the outer area 108 of the installation 100 and is configured to enable a workpiece 102 to be delivered to the loading device 110 through the outer workpiece passage 114 thereof and to enable a workpiece 102 to be taken up by the unloading device 130 through the outer workpiece passage 138 thereof.

The external transport device 150 can be configured, for example, as a handling device, for example as a robot.

The external transport device 150 preferably has at least three, particularly preferred at least four, in particular at least five, for example at least six, degrees of freedom.

The above-described installation 100 for cleaning and/or deburring workpieces 102 operates as follows:

With the outer door 118 at the outer workpiece passage 114 of the loading device 110 open, a workpiece to be treated is taken up by means of the external transport device 150 (for example by a workpiece conveyor system connected upstream of the installation 100) and placed on the linear workpiece movement arrangement 124 of the loading device 110.

The outer door 118 (and, if applicable, also the inner door 120) of the loading device 110 is then closed, and in a first work cycle of the installation 100 the workpiece 102 is guided past the treatment device 126 of the loading device 110.

During the movement of the workpiece 102 by means of the linear workpiece movement arrangement 124 the workpiece 102 is pretreated, for example precleaned and/or deburred.

The cleaning medium for this precleaning and, if applicable, for the deburring can be connected from the installation 100 by means of corresponding assemblies or be processed by separate assemblies for the treatment device 126 of the loading device 110.

During this work cycle of the installation 100 a second workpiece 102 is treated in the treatment region 104 and a third workpiece 102 is simultaneously subjected to an aftertreatment in the unloading device 130.

At the end of the first work cycle the inner door 120 of the loading device 110 on the treatment region side is opened and the workpiece 102 is taken up from the loading device 110 by the internal transport device 128 of the installation 100, transferred into the treatment region 104 through the inner workpiece passage 116 and delivered to the further treatment operation by means of the treatment device 107 in a second work cycle.

This main treatment in the treatment region 104 can be, for example, a high-pressure deburring operation and/or a cleaning operation.

During this second work cycle a further workpiece 102 is simultaneously subjected to an aftertreatment in the unloading device 130 and a new workpiece 102 is subjected to a pretreatment in the loading device 110.

After the treatment in the treatment region 104 the workpiece 102 is placed on the linear workpiece movement arrangement 144 of the unloading device 130 by the internal transport device 128 after the inner door 140 of the unloading device 130 at the inner workpiece passage 134 has been opened.

The third work cycle on the workpiece 102 begins after the inner door 140 has been closed.

While the workpiece 102 is moved past the treatment device 146 of the unloading device 130 by means of the linear workpiece movement arrangement 144 in the unloading chamber 132, an aftertreatment operation is conducted on the workpiece 102 by means of the treatment device 146.

This aftertreatment operation can be, for example, a flushing operation, a drying operation or a cleanness checking operation on the workpiece 102.

During this third work cycle of the installation 100 another workpiece 102 is simultaneously subjected to the main treatment in the treatment region 104 and a further workpiece 102 is subjected to a pretreatment in the loading device 110.

At the end of the third work cycle the outer door 142 of the unloading device 130 is opened and the workpiece 102 is removed through the outer workpiece passage 138 of the unloading device 130 by means of the external transport device 150 and set down in the outer area 108 to be taken up by a workpiece conveyor system connected downstream of the installation 100.

Because another workpiece 102 is pretreated in the loading device 110 and a further workpiece 102 is aftertreated in the unloading device 130 during the main process period in the treatment region 104 of the installation 100, optimal use is made of the cycle times of the installation 100, and the cleaning result is improved.

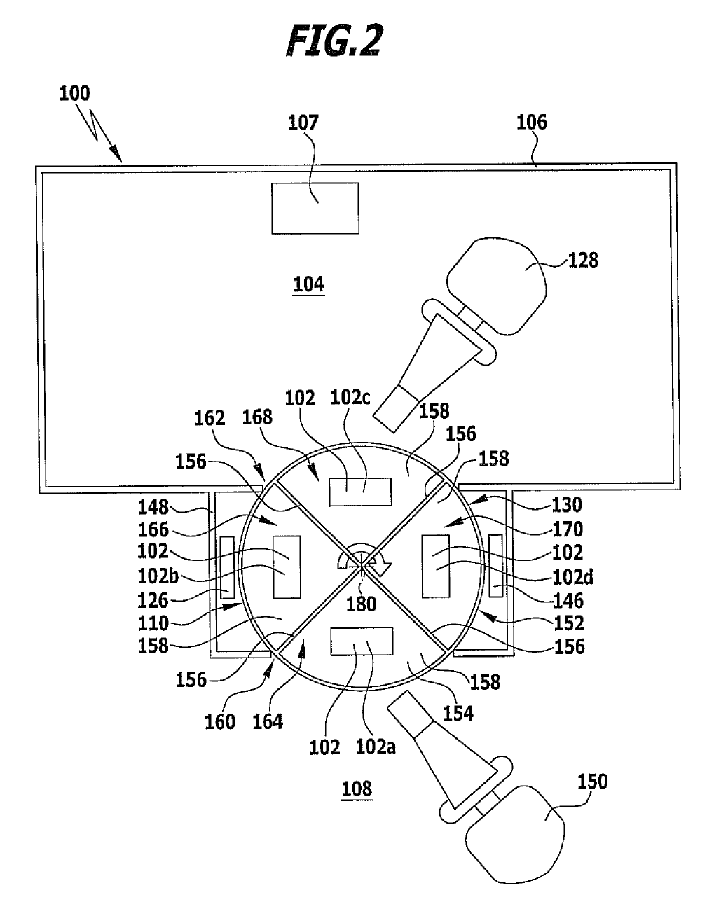

A second embodiment of an installation 100 for cleaning and/or deburring workpieces 102 shown in FIG. 2 differs from the first embodiment shown in FIG. 1 in that instead of a respective linear workpiece movement arrangement 124 or 144, the loading device 110 and the unloading device 130 have an associated common rotation device 152 for moving workpieces 102 from the outer area 108 of the installation 100 into the treatment region 104 and from the treatment region 104 into the outer area 108 of the installation 100.

The rotation device 152 comprises a circular rotary table 154, which is divided by partition walls 156 into a plurality of, for example four, segments 158, which can respectively accommodate a workpiece 102.

The rotary table 154 is rotatable around a preferably vertically oriented rotational axis 180 by means of a motor rotary drive device.

In each work cycle of the installation 100 the rotary table 154 rotates further by a respective angle of 360°/n, wherein n corresponds to the number of segments 158 of the rotary table 154.

If there are four segments 158, the rotary table 154 thus rotates respectively further by 90° with each work cycle.

The rotation device 152 is arranged in a loading and unloading housing 148 of the installation 100, which has an outer workpiece passage 160, through which a segment 158 of the rotation device 152 respectively extends into the outer area 108 of the installation 100, and an inner workpiece passage 162, through which a segment 158 of the rotation device 152 respectively extends into the treatment region 104 of the installation 100.

Moreover, a treatment device 126 of the loading device 110 and a treatment device 146 of the unloading device 130 are arranged in the loading and unloading housing 148.

Otherwise, the second embodiment shown in FIG. 2 is the same with respect to its structure as the first embodiment of the installation 100 for cleaning and/or deburring workpieces 102 shown in FIG. 1.

The second embodiment of an installation 100 operates as follows:

In a first work cycle a first workpiece 102a is placed by means of the external transport device 150 on the segment 158 of the rotation device 152 located in a first working position in the region of the outer workpiece passage 160 after, in the same work cycle, an already treated workpiece 102 from this segment 158 has been taken from the rotation device 152 by means of the external transport device 150 and set down in the outer area 108 of the installation 100 to then be taken up by a workpiece conveyor system connected downstream of the installation 100.

During this first work cycle a second workpiece 102b is simultaneously pretreated in the second working position 166 by means of the treatment device 126 of the loading device 110, in a third working position 168 a third workpiece 102c is taken up from the rotation device 152 by means of the internal transport device 128 and delivered to the main treatment operation in the treatment region 104 and then set down on the rotation device 152 again and in a fourth working position 170 a fourth workpiece 102d is aftertreated by means of the treatment device 146 of the unloading device 130.

The rotation device 152 is then rotated further by a cycle angle of 90°, for example.

In the following second work cycle the first workpiece 102a is pretreated at the second working position 166 by means of the treatment device 126 of the loading device 110.

This pretreatment can be, for example, a precleaning operation and/or a deburring operation, in particular a brush deburring operation, of the workpiece 102a.

The precleaning can be conducted with a cleaning system fixedly arranged in the loading and unloading housing 148.

The cleaning medium used for the precleaning or, if applicable, for the deburring can be connected from the installation 100 by means of corresponding assemblies or be processed separately by separate assemblies for the treatment device 126 of the loading device 110.

During the pretreatment of the workpiece 102a in the second working position 166 the second workpiece 102b is simultaneously subjected to the main treatment in the treatment region 104, the third workpiece 102c is aftertreated at the fourth working position 170 and at the first working position 164 the fourth workpiece 102d is taken up from the rotation device 152 by means of the external transport device 150 and replaced by a new workpiece 102. The rotation device 152 is then rotated further by the cycle angle of 90°, for example.

In the now following third work cycle the first workpiece 102a in the third working position 168 is taken from the rotation device 152 by means of the internal transport device 128 and delivered to the treatment device 107 in the treatment region 104 of the installation 100 to be subjected to a main treatment operation, for example a high-pressure deburring operation, and/or a cleaning operation.

After conclusion of the main treatment in the treatment region 104 the treated workpiece 102a is set down on the rotation device 152 again by means of the internal transport device 128.

During the same work cycle the second workpiece 102b is aftertreated at the fourth working position 170, while in the first working position the third workpiece 102c is taken up from the rotation device 152 by means of the external transport device 150 and is replaced by a new workpiece 102.

In the same work cycle a further workpiece 102 is additionally pretreated at the second working position 166.

The rotation device 152 is then rotated further by the cycle angle of 90°, for example.

In the now following fourth work cycle an aftertreatment is conducted on the first workpiece 102a in the fourth working position 170 by means of the treatment device 146 of the unloading device 130.

This aftertreatment can be, for example, a final cleaning operation by means of a cleaning system or a drying operation by means of a blowing system.

While the first workpiece 102a is aftertreated at the fourth working position 170, in the same work cycle the second workpiece 102b is taken up from the rotation device 152 by means of the external transport device 150 in the first working position 164 and is replaced by a new workpiece 102.

Another workpiece 102 is pretreated in the same work cycle at the second working position 166 and in the same work cycle a further workpiece 102 is subjected to the main treatment in the treatment region 104.

The rotation device 152 is then rotated further by the cycle angle of 90°, for example, and the installation 100 is once again in the first work cycle, in which the first workpiece 102a is taken up from the rotation device 152 by means of the external transport device 150 and replaced by a new workpiece 102.

In the same work cycle a workpiece 102 is pretreated at the second working position 166, another workpiece 102 is subjected to the main treatment in the treatment region 104 and finally a further workpiece 102 is aftertreated at the fourth working position.

Because another workpiece 102 is pretreated and a further workpiece 102 is aftertreated at the same time as the main treatment is conducted on the workpiece 102 in the treatment region 104, optimal use is made of the cycle times of the installation 100 and the cleaning result is improved.

1. Installation for cleaning and/or deburring workpieces, comprising
a treatment region configured to enable a cleaning treatment and/or a deburring treatment to be performed on a workpiece therein,
a loading device for transferring the workpiece from an outer area of the installation into the treatment region and
an unloading device for transferring the workpiece from the treatment region into the outer area of the installation,
wherein the loading device and/or the unloading device comprises at least one treatment device configured to enable the workpiece to be treated during the transfer between the outer area of the installation and the treatment region of the installation.

2. Installation according to claim 1, wherein the loading device comprises as treatment device a spray cleaning device, a dry cleaning device and/or a deburring device.

3. Installation according to claim 1, wherein the unloading device comprises as treatment device a flushing device, a drying device and/or a cleanness checking device.

4. Installation according to claim 1, wherein the unloading device comprises a rinsing device for rinsing off the workpiece with a flushing liquid and the installation comprises an analysing device for analysing the degree of contamination of the flushing liquid after rinsing off the workpiece.

5. Installation according to claim 1, wherein the installation comprises an internal transport device configured to enable the workpiece to be taken up by the loading device and delivered to the treatment operation in the treatment region and/or delivered to the unloading device after treatment in the treatment region.

6. Installation according to claim 1, wherein the installation comprises an external transport device configured to enable the workpiece to be delivered to the loading device and/or to be accepted from the unloading device.

7. Installation according to claim 1, wherein at least one treatment device of the loading device and/or the unloading device is static.

8. Installation according to claim 1, wherein at least one treatment device of the loading device and/or the unloading device is movable with the workpiece during the treatment.

9. Installation according to claim 1, wherein an outer workpiece passage between the outer area of the installation and the loading device and/or an outer workpiece passage between the outer area of the installation and the unloading device is closable by means of a door.

10. Installation according to claim 1, wherein an inner workpiece passage between the treatment region of the installation and the loading device and/or an inner workpiece passage between the treatment region of the installation and the unloading device is closable by means of a door.

11. Installation according to claim 1, wherein the loading device and/or the unloading device comprises a linear workpiece movement device.

12. Installation according to claim 1, wherein the loading device and/or the unloading device comprises a rotation device for moving the workpiece.

13. Installation according to claim 1, wherein the loading device and the unloading device have an associated common rotation device for moving the workpiece from the outer area of the installation into the treatment region and from the treatment region into the outer area of the installation.

14. Installation according to claim 13, wherein the rotation device has at least four working positions for the workpiece, into which the workpiece is movable in consecutive cycles.

15. Method for cleaning and/or deburring workpieces, comprising the following:
transferring a workpiece from an outer area of the installation into a treatment region of the installation;
conducting a cleaning treatment and/or a deburring treatment on the workpiece in the treatment region;
transferring the workpiece from the treatment region of the installation into the outer area of the installation,
wherein the workpiece is pretreated during the transfer from the outer area of the installation into the treatment region of the installation and/or is aftertreated during the transfer from the treatment region of the installation into the outer area of the installation.
